(19) United States
(12) Patent Application Publication
(10) Pub. No.: US 2006/0285681 A1
(43) Pub. Date: Dec. 21, 2006

(54) Foldable electronic devices

(75) Inventor: Yung-Tsun Hsieh, Pingtung County (TW)

Correspondence Address: QUINTERO LAW OFFICE, 1617 BROADWAY, 3RD FLOOR, SANTA MONICA, CA, 90404, US

(73) Assignee: BENQ CORPORATION, Taoyuan (TW)

(21) Appl. No.: 11/448,479

(22) Filed: Jun. 7, 2006

(30) Foreign Application Priority Data
Jun. 17, 2005 (TW) TW94120160

(51) Int. Cl. H04M 1/00

(52) U.S. Cl. 379/433.13

(57) ABSTRACT

Foldable electronic devices are provided. A foldable electronic device includes a main body, a cover, a hollow first pivot member fixed to the cover, a hollow second pivot member fixed to the main body, a lock mechanism and an electrical transmission media. The first pivot member includes a tubular body and a partition dividing the tubular body into a first space accommodating the lock mechanism, and a second space with the electrical transmission media passing therethrough to connect the main body and the cover. The second pivot member surrounds the first pivot member and is rotatable with respect to the first pivot member between a first position and a second position. When the second pivot member is in the first position, the lock mechanism projects outward through an opening of the first pivot member and engages with a recess of the second pivot member.

### BACKGROUND

The invention relates in general to foldable electronic devices and in particular to foldable electronic devices with hollow pivot mechanisms.

Referring to FIGS. 1A and 1B, a conventional foldable electronic device, such as a mobile phone, comprises a main body 10, a cover 20, a solid hinge H and a flexible printed circuit board F. The main body 10 comprises a pair of first pivot portions 101 and 102 on both sides thereof, and the cover 20 comprises a second pivot portion 201 pivotally connected to the first pivot portions 101 and 102.

As shown in FIG. 1A, the second pivot portion 201 pivotally connects the first pivot portion 102 at the right side, and pivotally connects the first pivot portions 101 at the left side via the hinge H. The cover 20 is rotatable with respect to the main body 10 by the first pivot portions 101 and 102, the second pivot portion 201 and the hinge H. Specifically, the flexible printed circuit board F passes through the first pivot portion 102 and the second pivot portion 102, such that the main body 10 and the cover 20 are electrically connected.

However, when more flexible printed circuit boards F or conductive wires are intended to be disposed through the pivot portions 102 and 103 at the right side for connection of the main body 10 and the cover 20, they are potentially difficult to arrange in such crowded space.

### SUMMARY

Foldable electronic devices are provided. A foldable electronic device includes a main body, a cover, a hollow first pivot member fixed to the cover, a hollow second pivot member fixed to the main body, a lock mechanism and an electrical transmission media. The first pivot member includes a tubular body and a partition dividing the tubular body into a first space accommodating the lock mechanism, and a second space with the electrical transmission media passing therethrough to connect the main body and the cover. The second pivot member surrounds the first pivot member and is rotatable with respect to the first pivot member between a first position and a second position. When the second pivot member is in the first position, the lock mechanism projects outward through an opening of the first pivot member and engages with a recess of the second pivot member.

### DESCRIPTION OF THE DRAWINGS

FIG. 1A is an exploded diagram of a conventional electronic device;

FIG. 1B is a perspective diagram of the conventional electronic device in FIG. 1;

FIG. 2A is an exploded diagram of an embodiment of an electronic device;

FIG. 2B is a perspective diagram of the electronic device in FIG. 2A;

FIGS. 3A and 3B are exploded diagrams of an embodiment of a pivot mechanism and a lock mechanism;

FIGS. 4A and 4B show a second pivot member situated in a first position;

FIGS. 5A and 5B show a second pivot member rotating from a first position to a second position; and

FIGS. 6A and 6B show a second pivot member situated in a second position.

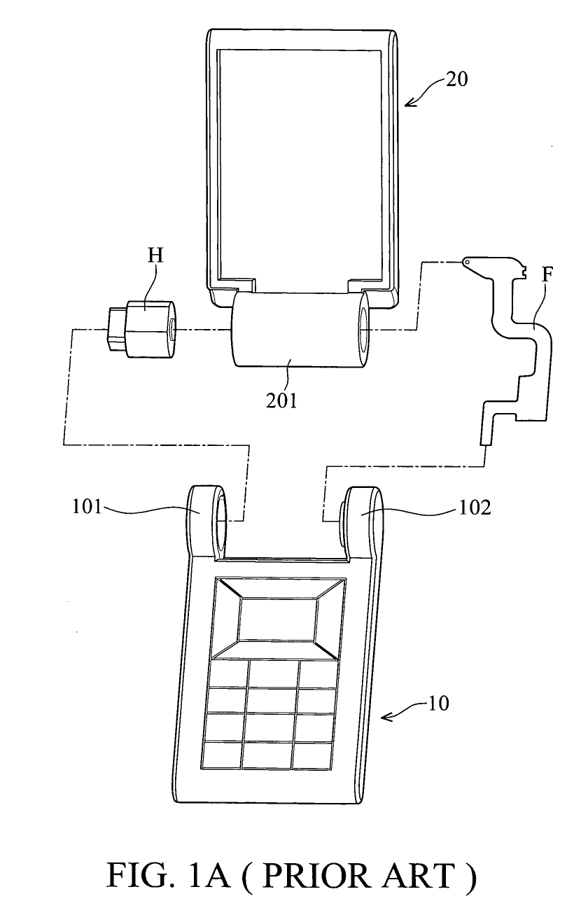

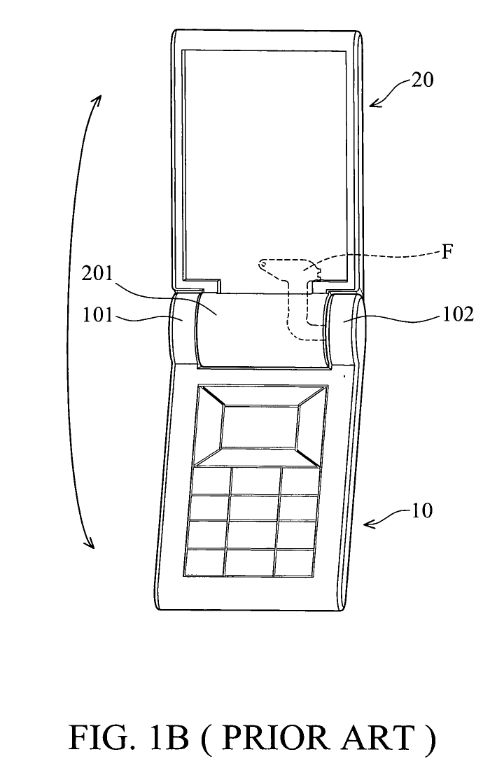

### DETAILED DESCRIPTION

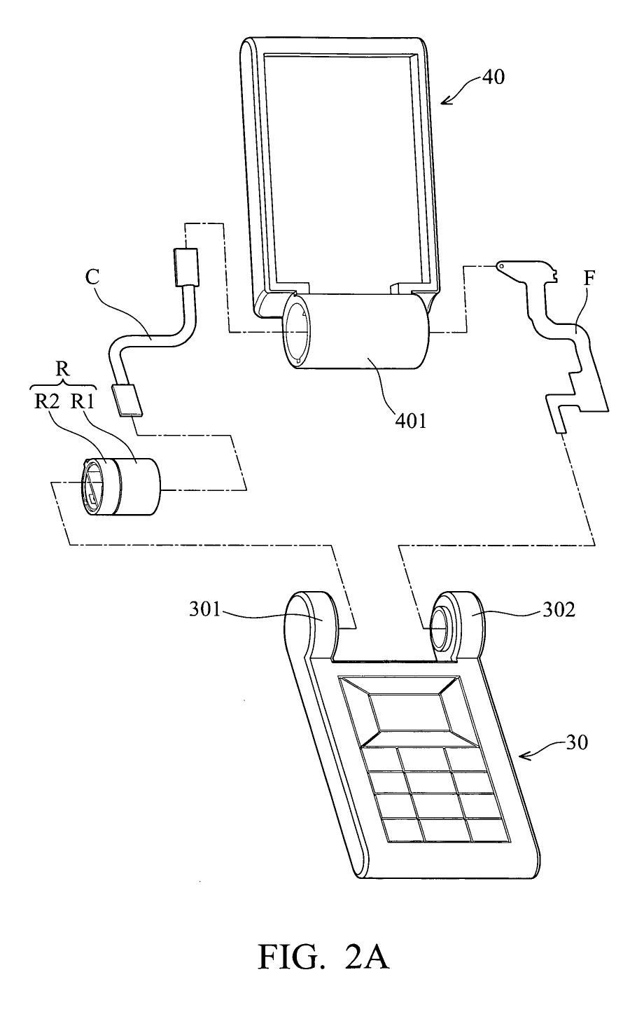

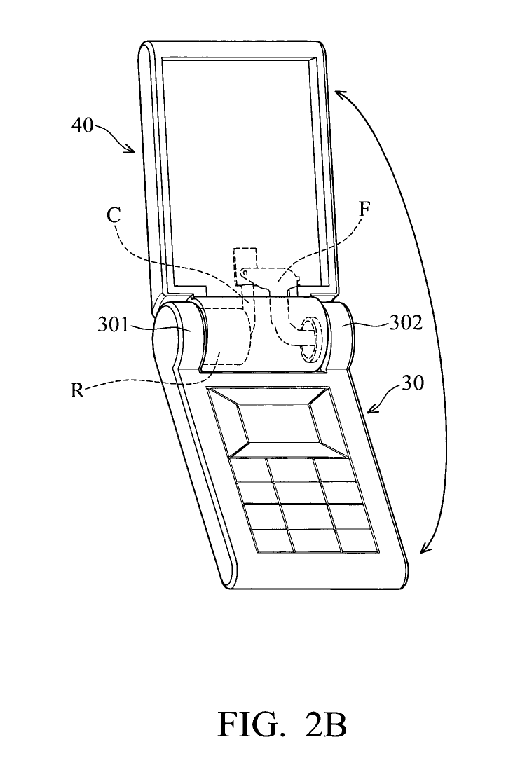

Referring to FIG. 2A, an exemplary embodiment of a foldable electronic device, such as a mobile phone, primarily comprises a main body 30, a cover 40, a pivot mechanism R, a flexible printed circuit board F, and a electrical transmission media C. The main body 30 comprises a pair of first pivot portions 301 and 302 on both sides thereof, and the cover 20 comprises a second pivot portion 401 pivotally connected to the first pivot portions 301 and 302. The main body 30 and the cover 40 are rotatable via the first pivot portions 301 and 302, the second pivot portion 401 and the pivot mechanism R.

With respect to FIGS. 2A and 2B, the second pivot portion 401 pivotally connects the first pivot portion 302 at the right side, and pivotally connects the first pivot portions 301 via the pivot mechanism R at the left side. The pivot mechanism R primarily comprises a hollow first pivot member R1 mounted in the second pivot portion 401 and a hollow second pivot member R2 mounted in the first pivot portions 301. Specifically, the first and second pivot members R1 and R2 are rotatably connected with the second pivot member R2 surrounding the peripheral of first pivot member R1, such that the main body 30 and the cover 40 are hinged.

As shown in FIGS. 2A and 2B, the flexible printed circuit board F passes through the first pivot portion 302 and the second pivot portion 402 at the right side, to electrically connect the main body 30 and the cover 40. At the left side, the electrical transmission media C, such as a coaxial wire, passes through the first pivot portion 301, the pivot mechanism R and the second pivot portion 402, to electrically connect the main body 30 and the cover 40. Interference can be avoided by routing the flexible printed circuit board F and the electrical transmission media C in different ways.

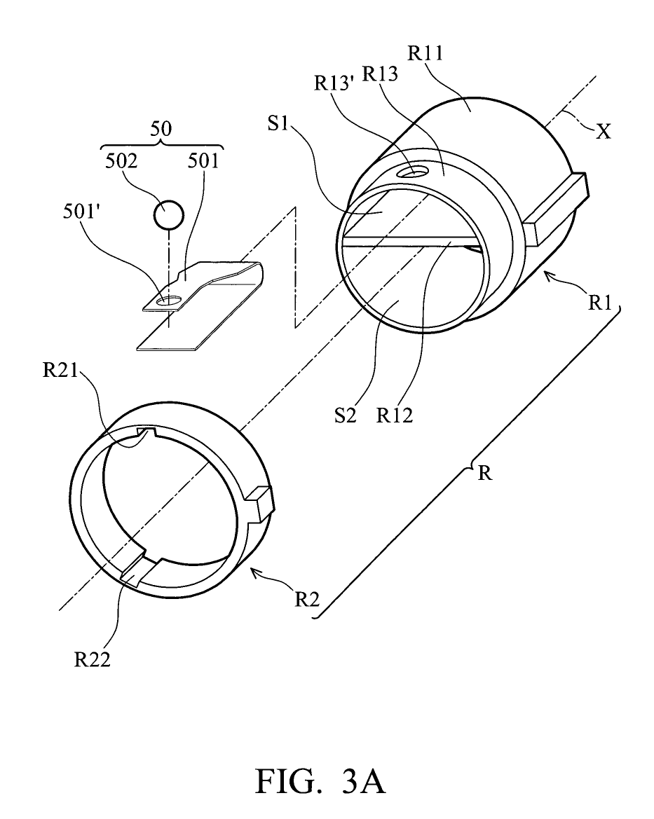

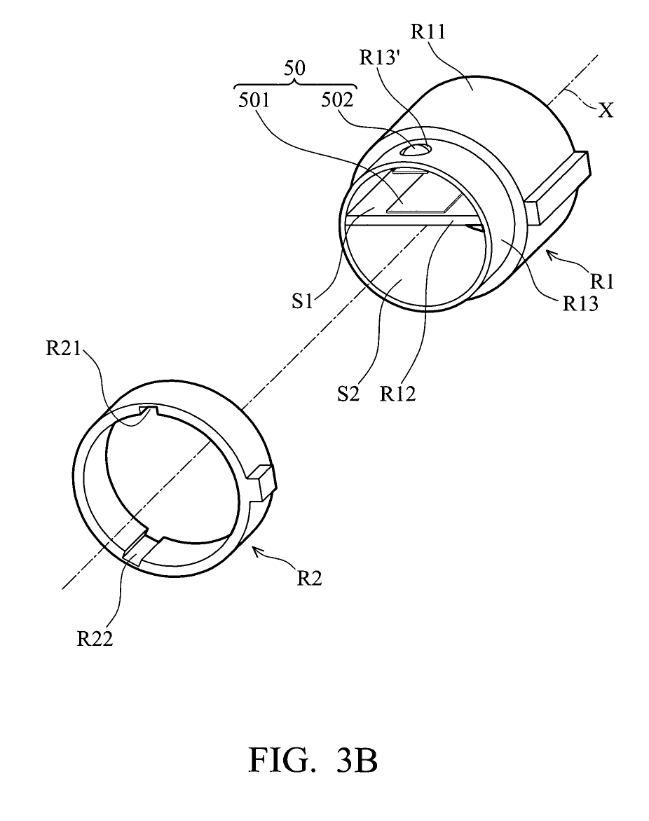

Referring to FIGS. 3A and 3B, an embodiment of the foldable electronic device further comprises a lock mechanism 50 disposed in the pivot mechanism R. As shown in FIG. 3A, the first pivot member R1 of the pivot mechanism R comprises a hollow tubular body R11 with a partition R12 disposed therein. The partition R12 is substantially along X axis, dividing the tubular body R11 into a first space S1 and a second space S2. In some embodiments, the second space S2 is lager than first space S1. A tubular flange R13 extending from the tubular body R11 along X axis comprises a hole R13′ disposed thereon, wherein the outer diameter of the tubular flange R13 is less than that of the tubular body R11.

As shown in FIG. 3A, the lock mechanism 50 is disposed in the first space S1, comprising a resilient member 501 and a ball-shaped lock member 502. In some embodiments, the resilient member 501 can be a flexible sheet or a spring. Referring to FIGS. 3A and 3B, the lock member 502 is gripped between the hole R13′ and an opening 501′ of the resilient member 501 by resilient force of the resilient member 501. Here, the dimension of the lock member 502 is greater than the hole R13′ and the opening 501′ to prevent sliding and separation of the lock member 502. Since the lock mechanism 50 is disposed in the first space S1, interference can be avoided by disposing the electrical transmission media C through the second space S2.

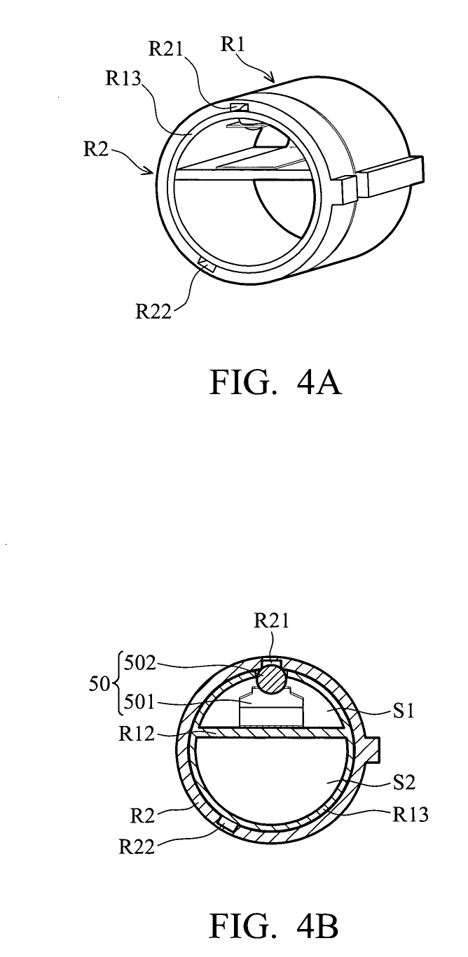

In FIGS. 4A and 4B, the second pivot member R2 is rotatable around the tubular flange R13 of the first pivot member R1. When the second pivot member R2 is in a first position with respect to the first pivot member R1, as shown in FIGS. 4A and 4B, the lock member 502 is pushed through the hole R13′ and projecting from the flange R13 by the resilient member 501. In FIG. 4B, the lock member 502 is engaged in a first recess R21 of the second pivot member R2, restraining rotation of the first and second pivot members R1 and R2.

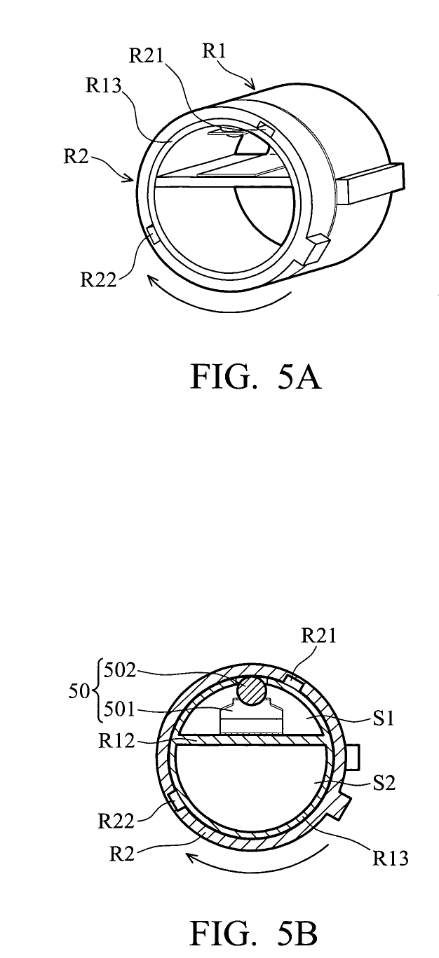

Referring to FIGS. 5A and 5B, as the second pivot member R2 rotates clockwise from the first position, the lock member 502 is retracted and released from the first recess R21. As shown in FIG. 5B, the resilient member 501 continuously forces the lock member 502 to abut an inner surface of the second pivot member R2.

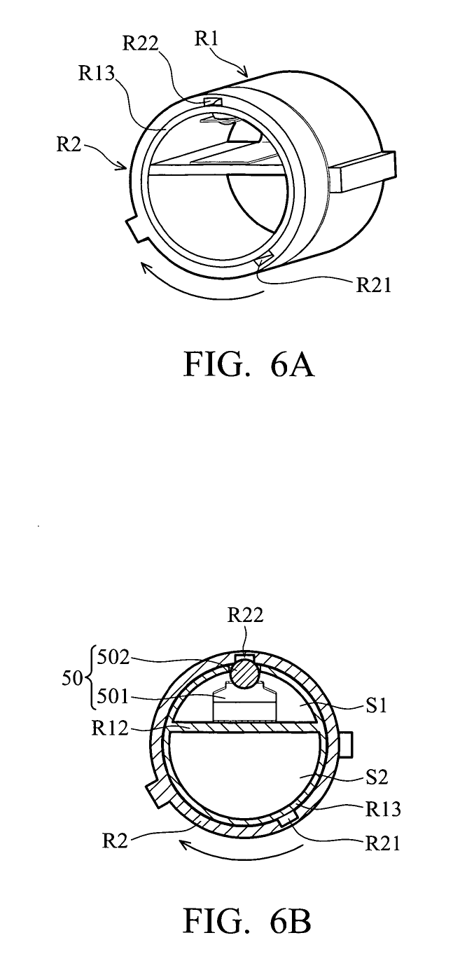

Referring to FIGS. 6A and 6B, as the second pivot member R2 rotates to a second position, the lock member 502 is pushed by the resilient member 501 through the hole R13′ and projecting from the tubular flange R13, such that the lock member 502 is engaged in a second recess R22 of the second pivot member R2, restraining rotation of the first and second pivot members R1 and R2.

When the second pivot member R2 rotates to the first positions or the second position, the lock mechanism 50 is snappingly engaged in a recess of the second pivot member R2 to restraining rotation of the first and second pivot members R1 and R2, holding the main body 30 and the cover 40 in a specific angle.

Foldable electronic devices with hollow pivot mechanisms are provided according to the embodiments. Interference of the flexible printed circuit board F and the electrical transmission media C can be avoided by routing in opposite sides. Moreover, the main body 30 and the cover 40 can be held at a specific angle by the lock mechanism 50 restraining rotation of the first and second pivot members R1 and R2 in predetermined positions.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A foldable electronic device, comprising:
a main body;
a cover, rotatable with respect to the main body around a first axis;
a first pivot member, fixed to the cover, comprising a tubular body and a partition disposed in the tubular body, wherein the tubular body comprises a hole, and the partition divides the tubular body into a first space and a second space;
a second pivot member fixed to the main body, comprising a first recess, wherein the second pivot member surrounds the first pivot member and is rotatable with respect to the first pivot member between a first position and a second position;
a lock mechanism, disposed in the first space, projecting through the hole and engaging with the first recess when the second pivot member is in the first position; and
an electrical transmission media, passing through the second space to electrically connect the main body and the cover.

2. The foldable electronic device as claimed in claim 1, wherein the lock mechanism comprises a lock member and a resilient member abutting between the partition and the lock member, and the lock member is gripped within the opening by resilient force of the resilient member.

3. The foldable electronic device as claimed in claim 2, wherein when the second pivot member is in the first position, the lock member is pushed through the opening and engaged in the first recess by the resilient member.

4. The foldable electronic device as claimed in claim 2, wherein the lock member is ball-shaped.

5. The foldable electronic device as claimed in claim 2, wherein a diameter of the lock member is greater than a diameter of the hole.

6. The foldable electronic device as claimed in claim 2, wherein the resilient member comprises an opening with the lock member disposed therein.

7. The foldable electronic device as claimed in claim 2, wherein the resilient member comprises a flexible sheet.

8. The foldable electronic device as claimed in claim 2, wherein the resilient member comprises a spring.

9. The foldable electronic device as claimed in claim 2, wherein the lock member abuts an inner surface of the second pivot member when the second pivot member rotates between the first and second positions.

10. The foldable electronic device as claimed in claim 1, wherein the tubular body further comprises a tubular flange surrounded by the second pivot member.

11. The foldable electronic device as claimed in claim 10, wherein the hole is disposed on the tubular flange, and the lock member projects outward from the tubular flange when the second pivot member is in the first position.

12. The foldable electronic device as claimed in claim 1, wherein the first recess is disposed on an inner surface of the second pivot member.

13. The foldable electronic device as claimed in claim 1, wherein the second pivot member further comprises a second recess disposed on an inner surface thereof, and the lock member passes through the hole and engages with the second recess when the second pivot member is in the first position.

14. The foldable electronic device as claimed in claim 1, wherein the main body comprises a hollow first pivot portion disposed on a side thereof with the first pivot member mounted therein, and the cover comprises a hollow second pivot portion with the second pivot member mounted therein.

15. The foldable electronic device as claimed in claim 1, wherein the second space is greater than the first space.

16. The foldable electronic device as claimed in claim 1, wherein the electrical transmission media comprises a flexible printed circuit board.

17. The foldable electronic device as claimed in claim 1, wherein the electrical transmission media comprises a coaxial cable.
